(19) United States
(12) Patent Application Publication
(10) Pub. No.: US 2011/0050647 A1
(43) Pub. Date: Mar. 3, 2011

(54) TOUCH SYSTEM AND DISPLAY DEVICE COMPRISING THE SAME

(75) Inventors: Hyo-Seung LEE, Seongnam-si (KR); Ki-Suk SEONG, Seoul (KR); Seen-Suk KANG, Seongnam-si (KR)

(73) Assignee: NEO WINE CO., LTD., Seongnam-si (KR)

(21) Appl. No.: 12/860,080

(22) Filed: Aug. 20, 2010

(30) Foreign Application Priority Data
Aug. 28, 2009 (KR) 10-2009-0080321

(51) Int. Cl. G06F 3/042

(52) U.S. Cl. 345/175

(57) ABSTRACT

Provided is a touch system. The touch system comprises: a substrate; an optical sensor module comprising a light emitting unit and a light receiving unit disposed on the bottom of the substrate to be adjacent to each other; and sensing control circuit driving the light emitting unit and sensing whether or not a user's touch is made on the substrate on the basis of a sensing signal sensed through the light receiving unit.

### BACKGROUND OF THE INVENTION

1. Field of the Invention

An exemplary embodiment relates to a touch system technology, and more particularly, to a touch system capable of performing a reliable sensing operation against external light and a display device comprising the same.

2. Description of the Related Art

As a known touch sensor, a capacitive type touch sensor is generally used, which detects a user's touch position by sensing a change in capacitance of the touch sensor, which occurs at a contact portion when a human body having higher permittivity than air touches the touch sensor.

In the capacitive touch sensor, the touch sensing operation is sensitively reacting to a shape of an electrode formed on a circuit substrate at a touch position. Therefore, the sensitivity of the touch sensing operation will be various depending on the electrode and a permittivity of a dielectric surrounding the same.

In recent years, a touch sensor using an optical sensor module has been developed. The touch sensor of the optical sensor module senses light emitted by the optical sensor module through a light receiving unit.

However, the touch sensor of the optical sensor module senses whether or not a user's touch is made at a position which a user does not actually touch because reflected light by the user's touch and light incident from the outside are sensed by the light receiving unit. This causes a malfunction of the touch sensor and deteriorates the reliability of the touch sensor.

### SUMMARY OF THE INVENTION

The present invention has been made in an effort to provide a touch system capable of performing a reliable touch sensing operation against external light.

Further, the present invention has been made in an effort to provide a display device comprising the touch system capable of performing the reliable touch sensing operation against the external light.

An exemplary embodiment of the present invention provides a touch system that comprises: a substrate; an optical sensor module comprising a light emitting unit and a light receiving unit disposed on the bottom of the substrate to be adjacent to each other; and sensing control circuit driving the light emitting unit and sensing whether or not a user's touch is made on the substrate on the basis of a sensing signal sensed through the light receiving unit.

The sensing control circuit comprises a pulse generator outputting a pulse signal of a first frequency band; a filter filtering the sensing signal outputted from the light receiving unit in the first frequency band; and a comparator comparing the pulse signal with a signal filtered by the filter and senses whether or not the user's touch is made in accordance with a comparison result.

Another exemplary embodiment of the present invention provides a touch system that comprises: a backlight unit; a panel unit positioned on the top of the backlight unit and comprising at least one light receiving transistor; and a sensing control circuit driving the backlight unit and sensing whether or not a user's touch is made on the panel unit on the basis of a sensing signal sensed by at least one light receiving transistor.

The sensing control circuit comprises: a pulse generator outputting a pulse signal of a second frequency band; a filter filtering the sensing signal outputted from the light receiving unit in the second frequency band; and a comparator comparing the pulse signal with a signal filtered by the filter and sensing whether or not a user's touch is made in accordance with a comparison result.

Yet another exemplary embodiment of the present invention provides a display device that comprises: a display panel outputting an image; a touch system positioned on the top of the display panel to display the image to a user and sensing whether or not a user's touch is made output a touch coordinate; and a controller for controlling an operation of the display panel on the basis of the touch coordinate.

According to a touch system and a display device comprising the same according to an exemplary embodiment of the present invention, it is possible to filter noise generated by light incident from the outside by controlling an optical sensor module of the touch system to operate in a predetermined frequency band. Accordingly, it is possible to detect a coordinate of a user's touch position by accurately sensing the user's touch position and to implement a reliable touch system and a display device comprising the same.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a touch system according to an exemplary embodiment of the present invention;

FIG. 2 is diagram showing a waveform depending on an operation of the touch system of FIG. 1;

FIG. 3 is a schematic block diagram of a touch system according to another exemplary embodiment of the present invention; and

FIG. 4 is a schematic block diagram of a display device of a touch structure according to an exemplary embodiment of the present invention.

### DETAILED DESCRIPTION OF THE PREFERRED EMBODIMENTS

The accompanying drawings illustrating exemplary embodiments of the present invention and contents described in the accompanying drawings should be referenced in order to fully appreciate operational advantages of the present invention and objects achieved by the exemplary embodiments of the present invention.

Hereinafter, the present invention will be described in detail by describing exemplary embodiments of the present invention with reference to the accompanying drawings. Like elements refer to like reference numerals shown in the drawings.

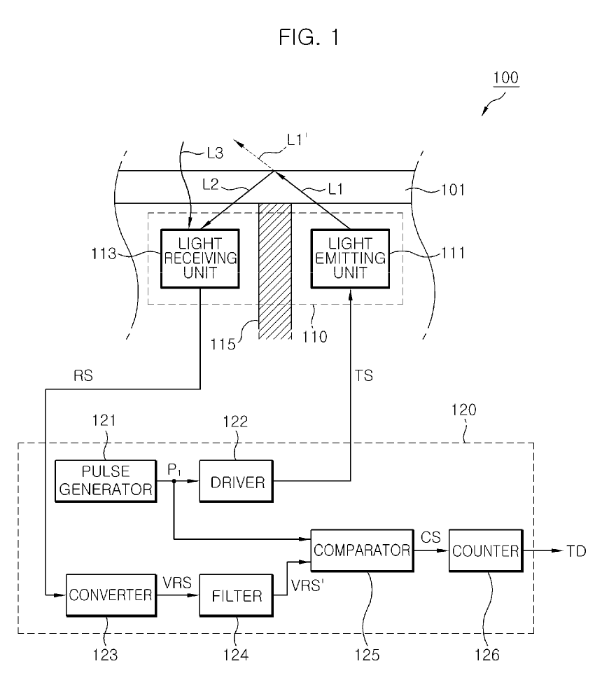

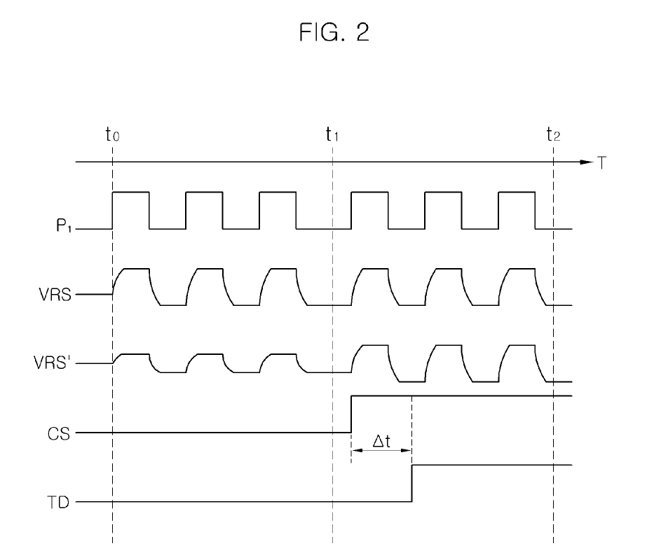

FIG. 1 is a schematic block diagram of a touch system according to an exemplary embodiment of the present invention and FIG. 2 is diagram showing a waveform depending on an operation of the touch system of FIG. 1.

Referring to FIG. 1, the touch system 100 according to the exemplary embodiment may comprise a substrate 101, an optical sensor module 110 and a sensing control circuit 120.

The substrate 101 may be made of a transparent material, i.e., an acryl or transparent resin, glass, or the like. The substrate 101 may transmit light outputted from a light emitting unit 111 to be described below, i.e., first light L1 to the outside

(L1′) or transmit light inputted from the outside, i.e., third light L3 to a light receiving unit 113.

The optical sensor module 110 may be disposed on the bottom of the substrate 101. The optical sensor module 110 may comprise two sensors disposed adjacent to each other, i.e., the light emitting unit 111 and the light receiving unit 113. The light emitting unit 111 and the light receiving unit 113 may be a light emitting diode, a photo diode, or a pinned photo diode, but are not limited thereto.

The light emitting unit 111 may light or flicker at a predetermined frequency in response to a drive signal TS outputted from the sensing control circuit 120. For example, the sensing control circuit 120 may output a drive signal TS for controlling the light emitting unit 111 to light or flicker at several to hundreds of KHz in order to prevent the light receiving unit 113 from being influenced by the third light L3 inputted from the outside.

The light receiving unit 113 may output a sensing signal RS by sensing reflected light generated when the first light L1 outputted from the light emitting unit 111 is reflected by the substrate 101, i.e., second light L2 or the third light L3 inputted from the outside.

The sensing control circuit 120 may sense whether or not a user's touch is made by extracting only a signal in a predetermined frequency band, i.e., a sensing signal RS in the same frequency band as a frequency band of the drive signal TS from the sensing signal RS outputted from the light receiving unit 113.

A light shielding wall 115 may be formed between the light emitting unit 111 and the light receiving unit 113. The light shielding wall 115 may prevent the light L1 outputted from the light emitting unit 111 from being directly inputted into the light receiving unit 113 without being reflected through the substrate 101. The light shielding wall 115 may be made of a material absorbing or fully reflecting light without transmitting the light, According to the exemplary embodiment, the light shielding wall 115 may be formed even between a pair of optical sensor modules adjacent to each other.

The sensing control circuit 120 may comprise a light emitting unit control circuit and a light receiving unit control circuit.

The light emitting unit control circuit may include a pulse generator 121 and a driver 122.

The pulse generator 121 may generate and output a pulse signal P1 having a predetermined frequency band, i.e., a first frequency band. The first frequency band may be one frequency band among frequency bands of several to hundreds of KHz and may be changed depending on the exemplary embodiments.

The driver 122 may generate and output the drive signal TS from the pulse signal P1 of the first frequency band. The driver 122 may generate the drive signal TS for operating the light emitting unit 111 by amplifying the pulse signal P1.

The light receiving unit control circuit may include a converter 123, a filter 124, a comparator 125, and a counter 126.

The converter 123 may convert and output the sensing signal RS outputted from the light receiving unit 113 into a voltage signal VRS.

The filter 124 filters a predetermined frequency from the voltage signal VRS converted by the converter 123, i.e., only the same frequency band as the first frequency band of the driving signal TS to output a filtered signal VRS′. The filter 124 may be a band pass filter, but is not limited thereto.

The comparator 125 may output a comparison result CS by comparing the pulse signal P1 outputted from the pulse generator 121 with the filtered signal VRS′ outputted from the filter 124.

The comparator 125 may output a comparison result CS having a first level, i.e., a low level when the filtered signal VRS′ and the pulse signal P1 deviate from an error range so as not to be the same as each other. Further, the comparator 125 may output a comparison result CS having a second level, i.e., a high level when the filtered signal VRS′ and the pulse signal P1 are the same as each other within the error range.

The counter 126 may output a touch sensing signal TD in response to the comparison result CS outputted from the comparator 125. For example, the counter 126 may count the comparison result CS for a predetermined counting time and output the touch sensing signal TD for detecting whether or not the user's touch is made in accordance with a counting result. At this time, the counter 126 may control user's touch sensitivity of the touch system 100 by controlling the counting time.

Referring to FIGS. 1 and 2, for t0-t1 of a time axis T, the pulse generator 121 of the sensing control circuit 120 may output the pulse signal P1 of the first frequency band. The first frequency band of the pulse signal P1 is different from the frequency band of the third light L3 inputted from the outside.

The driver 122 may output the drive signal TS based on the pulse signal P1 and the light emitting unit 111 may output the first light L1 in response to the drive signal TS.

For the time t0-t1 of the time axis T, when the user's touch is not inputted into the substrate 101, the first light L1 outputted from the light emitting unit 111 may be outputted to the outside (L1′) or the second light L2 reflected by the substrate 101 may be inputted into the light receiving unit 113. Further, the third light L3 inputted from the outside may be inputted into the light receiving unit 113.

Herein, the first light L1 outputted from the light emitting unit 111 may be represented by a sum of the light L1′ outputted from the outside and the second light L2 inputted into the light receiving unit 113. Since the user's touch is not inputted, the second light L2 may have a size smaller than the light L1′ outputted to the outside.

The light receiving unit 113 may output the sensing signal RS sensed by the second light L2 and the third light L3 and the converter 123 may convert and output the sensing signal RS into the voltage signal VRS.

The filter 124 may filter and output a signal of a predetermined frequency band, that is, a voltage signal VRS of the same frequency band as the first frequency band of the drive signal from the converted voltage signal VRS. At this time, since the signal sensed by the light receiving unit 113 has a frequency band different from the voltage signal VRS by the third light L3 inputted from the outside, the corresponding signal may be removed by the filter 124.

The comparator 125 may output a comparison result CS by comparing the pulse signal P1 with the filtered signal VRS′.

For example, since the user's touch is not inputted at the time t0-t1 of the time axis T, the signal VRS′ filtered by the filter 124 may be represented in a smaller size than the pulse signal P1 and the comparator 125 may output the comparison result CS having the first level.

The counter 126 may output a touch sensing signal TD having the first level on the basis of the comparison result CS outputted from the comparator 1. The sensing control circuit 120 may recognize that a user does not perform the touch input in the touch system 100 on the basis of the touch sensing signal TD having the first level.

Meanwhile, for a time t1-t2 of the time axis T, when the user's touch is inputted into the substrate 101, the first light L1 outputted from the light emitting unit 111 may be inputted into the light receiving unit 113 as the second light L2 by being reflected by the substrate 101 and the user's touch. Further, the third light L3 inputted from the outside may be inputted into the light receiving unit 113.

Herein, the first light L1 outputted from the light emitting unit 111 may be full-reflected by the substrate 101 and the user's touch and the reflected second light L2 may be full-reflected in the same manner as the first light L1 within the error range.

The light receiving unit 113 may output the sensing signal RS sensed by the second light L2 and the third light L3 and the converter 123 may convert and output the sensing signal RS into the voltage signal VRS.

The filter 124 may filter and output the voltage signal VRS at the same frequency band as the first frequency band of the drive signal TS from the converted voltage signal VRS. At this time, the signal which the light receiving unit 113 receives light by the third light L3 may be removed by the filter 124.

The comparator 125 may output a comparison result CS by comparing the pulse signal P1 with the filtered signal VRS′.

For example, since the user's touch is inputted for the time t1-t2 of the time axis T, the filtered signal VRS′ may be represented by the same size as the pulse signal P1 within the error range. In addition, the comparator 125 may output a comparison result CS having the second level.

The counter 126 counts the comparison result CS having the second level for the predetermined counting time Δt and may output the touch sensing signal TD having the second level on the basis of the counting result.

For example, the counter 126 may count the comparison result CS having the second level for a predetermined counting time Δt of approximately 3 seconds and may output the touch sensing signal TD having the second level on the basis of the counting result.

The counting time Δt of the counter 126 may be controlled by those skilled in the art or a user (i.e., an end user) and may control the user's touch sensitivity of the touch system 100.

The sensing control circuit 120 may recognize that the user perform the touch input in the touch system 100 on the basis of the touch sensing signal TD having the second level.

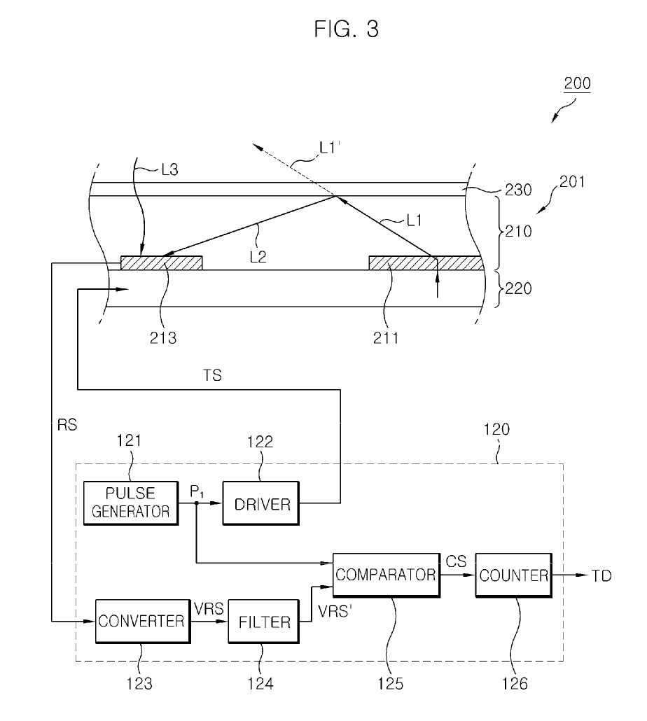

FIG. 3 is a schematic block diagram of a touch system according to another exemplary embodiment of the present.

Referring to FIG. 3, the touch system 200 according to the exemplary embodiment may comprise a panel assembly 201 and a sensing control circuit 120. The sensing control circuit 120 of the exemplary embodiment may be the same as the sensing control circuit 120 of the touch system 100 shown in FIG. 1.

The panel assembly 201 may comprise a panel unit 210, a backlight unit 220, and a protection layer 230.

The panel unit 210 may display an image by using light provided from the backlight unit 220. The panel unit 210 may be a liquid crystal panel charged with liquid crystals therein, but may be a PDP panel or an organic EL panel.

The panel unit 210 may comprise a plurality of thin film transistors (TFTs). For example, the panel unit may comprise a drive transistor 211 and a light receiving transistor 213 used as the light receiving unit. The plurality of light receiving transistors 213 may be formed adjacent to the drive transistor 211.

The backlight unit 220 operates by a drive signal TS provided from the sensing control circuit 120 to provide light to the panel unit 210. The backlight unit 220 may be used as a light emitting unit. The backlight unit 220 may be configured by a cold cathode fluorescent lamp (CCFL) or a light emitting diode (LED).

The protection layer 230 may protect the panel unit 210 from the outside by covering the whole surface of the panel unit 210. The protection layer 230 may be made of a transparent material, i.e., an acryl or transparent resin, or the like.

The sensing control circuit 120 may comprise the light emitting unit control circuit and the light receiving unit control circuit as described with reference to FIG. 1.

The light emitting unit control circuit may control operations of the panel assembly 201 and the backlight unit 220. The light emitting unit control circuit may comprise a pulse generator 121 and a driver 122.

The pulse generator 121 may generate and output a pulse signal P1 having a predetermined frequency band, i.e., a second frequency band. The second frequency band may be, for example, any one of the frequency bands of several MHz.

The driver 122 may generate and output the drive signal TS from the pulse signal P1 of the second frequency band. The backlight unit 220 may be lighted or flickered in the second frequency band in response to the drive signal TS outputted from the driver 122.

The light receiving unit control circuit may sense the user's touch input from the sensing signal RS outputted form the light receiving transistor 213 of the panel assembly 201. The light receiving unit control circuit may comprise a converter 123, a filter 124, a comparator 125, and a counter 126. Operations of the components are the same as those described with reference to FIGS. 1 and 2.

That is, the light receiving unit control circuit of the exemplary embodiment may perform the same operation as the operation of the light receiving unit control circuit shown in FIG. 1 except for receiving the sensing signal RS from the light receiving transistor 213 of the panel assembly 201.

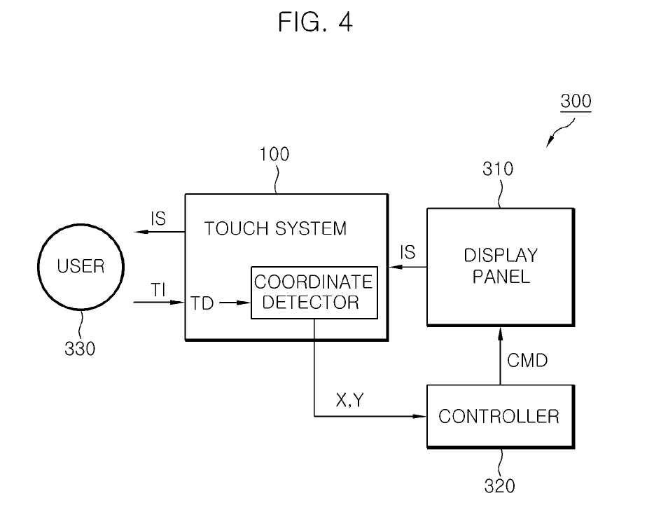

FIG. 4 is a schematic block diagram of a display device of a touch structure according to an exemplary embodiment of the present invention. In the exemplary embodiment, for easy description, the display device of the touch structure comprising the touch system shown in FIG. 1 will be described.

Referring to FIGS. 1 and 4, the display device 300 of the touch structure according to the exemplary embodiment may comprise a touch system 100, a display panel 310, and a controller 320.

The touch system 100 may comprise an optical sensor module 110 and a sensing control circuit 120. The touch system 100 may further comprise a coordinate detector 150 capable of outputting a touch position of a user 330 from a touch sensing signal TD outputted from the sensing control circuit 120 depending on a touch input TI of the user 330 as a touch coordinate (X, Y).

The touch system 100 may be positioned on the top of the display panel 310. The touch system 100 may display an image IS provided from the display panel 310 to the user 330 and output the touch coordinate (X, Y) by sensing the touch input from the user.

The display panel 310 is positioned on the bottom of the touch system 100 and may provide the image IS to the user 330 through the touch system 100. The display panel 310 may display panels such as a CRT, an LCD, a PDP, and the like and employ all known display devices.

The controller 320 may output at least one command signal CMD for controlling an operation of the display panel 310 on the basis of the touch coordinate (X, Y) provided from the touch system 100.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. A touch system, comprising:
a substrate;
an optical sensor module comprising a light emitting unit and a light receiving unit disposed on the bottom of the substrate to be adjacent to each other; and
a sensing control circuit driving the light emitting unit and sensing whether or not a user's touch is made on the substrate on the basis of a sensing signal sensed through the light receiving unit,
wherein the sensing control circuit comprises,
a pulse generator outputting a pulse signal of a first frequency band;
a filter filtering the sensing signal outputted from the light receiving unit in the first frequency band; and
a comparator comparing the pulse signal with a signal filtered by the filter and sensing whether or not the user's touch is made in accordance with a comparison result.

2. The touch system according to claim 1, wherein the sensing control circuit further comprises a counter outputting a touch sensing signal by counting the comparison result for a predetermined time.

3. The touch system according to claim 1, wherein the sensing control circuit further comprises a coordinate detector detecting a touch coordinate depending on whether or not the user's touch is made.

4. A touch system, comprising:
a backlight unit;
a panel unit positioned on the top of the backlight unit and comprising at least one light receiving transistor; and
a sensing control circuit driving the backlight unit and sensing whether or not a user's touch is made on the panel unit on the basis of a sensing signal sensed by at least one of the light receiving transistor,
wherein the sensing control circuit includes,
a pulse generator outputting a pulse signal of a second frequency band;
a filter filtering the sensing signal outputted from the light receiving unit in the second frequency band; and
a comparator comparing the pulse signal with a signal filtered by the filter and sensing whether or not the user's touch is made in accordance with a comparison result.

5. The touch system according to claim 4, wherein the sensing control circuit further comprises a counter outputting a touch sensing signal by counting the comparison result for a predetermined time.

6. The touch system according to claim 4, wherein the sensing control circuit further comprises a coordinate detector detecting a touch coordinate depending on whether or not the user's touch is made.

7. A display device, comprising:
a display panel;
a touch system positioned on the top of the display panel and sensing whether or not a user's touch is made; and
a controller for controlling an operation of the display panel,
wherein the touch system comprises,
a substrate;
an optical sensor module comprising a light emitting unit and a light receiving unit disposed on the bottom of the substrate to be adjacent to each other; and
a sensing control circuit driving the light emitting unit and sensing whether or not a user's touch is made on the substrate on the basis of a sensing signal sensed through the light receiving unit,
and the sensing control circuit comprises,
a pulse generator outputting a pulse signal of a first frequency band;
a filter filtering the sensing signal outputted from the light receiving unit in a first frequency band; and
a comparator comparing the pulse signal with a signal filtered by the filter and sensing whether or not a user's touch is made in accordance with a comparison result.

8. The display device according to claim 7, wherein the sensing control circuit further comprises a counter outputting a touch sensing signal by counting the comparison result for a predetermined time.

9. The display device according to claim 7, wherein the sensing control circuit further comprises a coordinate detector detecting a touch coordinate depending on whether or not the user's touch is made.
